(19) United States
(12) Patent Application Publication
(10) Pub. No.: US 2001/0022407 A1
(43) Pub. Date: Sep. 20, 2001

(54) Method of producing a composite component with a foamed surface

(76) Inventor: Friedhelm Beckmann, Hiddenhausen (DE)

Correspondence Address: LERNER AND GREENBERG, P.A., POST OFFICE BOX 2480, Hollywood, FL, 33022-2480, US

(21) Appl. No.: 09/796,253

(22) Filed: Feb. 28, 2001

(30) Foreign Application Priority Data
Feb. 28, 2000 (DE) 100 09 470.8

(51) Int. Cl. B29C 67/00

(52) U.S. Cl. 264/46.4

(57) ABSTRACT

A composite component is produced with a foamed surface. A substrate part having a surface to be coated is placed into a mold, a layer of an unfoamed or merely pre-foamed, foamable material is applied to the surface of the substrate part at a first temperature, and the foamable material is expanded at a second temperature or a sequence of temperatures that are higher than the first temperature. The expansion is effected with a chemical blowing agent or a blowing agent mixture, so that the foamable material in the expanded state fills an intermediate space between the surface of the substrate part and a molding surface of the mold and, on the one hand, bonds with the surface of the substrate part and, on the other hand, comes to bear against the molding surface.

### BACKGROUND OF THE INVENTION

### FIELD OF THE INVENTION

The invention relates to a method of producing a composite component with a foamed surface.

In the use of components with decorative surfaces, increasingly higher requirements have to be met with respect to their appearance and feel, in particular in the case of paneling parts in the vehicle sector. To allow the desired properties to be achieved, materials which are applied to a solid substrate or core material in an additional operation are therefore used.

In the simplest case, so-called soft coating systems, which are sprayed onto the component in a layer thickness of approximately 40 to 70 μm, are used. However, this does not produce adequate feel in all cases, so that foam films, made for example of TPO or PVC, are used as an alternative to this. However, these films are quite expensive, not only the actual value of the material but also the application of the foam sheets additionally increasing the costs. In addition, in those cases in which the substrate material and the foam material are not compatible, complex pretreatment methods have to be used.

### SUMMARY OF THE INVENTION

The object of the present invention is to provide a method of producing a composite structure with a foamed surface which overcomes the above-noted deficiencies and disadvantages of the prior art devices and methods of this general kind, and which allows a material of a favorable appearance and feel to be applied directly and which leads to a coating that can be adjusted in hardness.

With the above and other objects in view there is provided, in accordance with the invention, a method of producing a composite component with a foamed surface, which comprises the steps of:

placing a substrate part having a surface to be coated into a mold;

applying a layer of an unfoamed or merely pre-foamed, foamable material to the surface of the substrate part at a first temperature; and

expanding the foamable material at a second temperature (or a sequence of temperatures) higher than the first temperature, with at least one expanding aid selected from the group consisting of a chemical blowing agent, a blowing agent mixture, and microspheres, such that the

foamed material in an expanded state fills an intermediate space between the surface of the substrate part and a molding surface of the mold and, on the one hand, bonds with the surface of the substrate part and, on the other hand, comes to bear against the molding surface.

In accordance with an added feature of the invention, the substrate part is produced in a same mold as the composite component.

In accordance with an additional feature of the invention, the substrate part is formed by injection molding, extrusion, or extrusion blow molding.

In accordance with another feature of the invention, the substrate part is harder than the expanded material and consists, in particular, of a microcellular foam.

In accordance with an alternative feature of the invention, the substrate part consists of a foam material that is softer than the expanded material.

In accordance with again another feature of the invention, during or after the step of applying the foamable material to the surface of the substrate part, the foamable material is expanded at the first temperature with a physical blowing agent and the foamable material is subsequently further expanded at the second temperature with a chemical blowing agent and/or a blowing agent mixture.

In accordance with again an added feature of the invention, the foamable material is applied to the substrate part with an injection-molding, extrusion, or extrusion blow-molding process.

In accordance with again an additional feature of the invention, a grain impression is formed on the expanded material with a suitable molding surface of the mold.

In accordance with again another feature of the invention, material for an initially unmolded substrate part is introduced into the mold, the foamable material is applied to the material and the foamable material is subsequently expanded and then the substrate is molded. In the alternative, the substrate is first molded and then the foamable material is expanded.

In accordance with again another feature of the invention, a decorative material is applied to the still unfoamed, foamable material and then the foamable material is expanded.

In accordance with again a further feature of the invention, the cavity of the mold is increased in size prior to the expanding step.

In accordance with a concomitant feature of the invention, the heat quantity required for expanding the foamable material is at least partly introduced via the heat content of the mold.

In other words, the objects of the invention are achieved by a method of producing a composite component with a foamed surface in which a substrate part having a surface to be coated is placed into a mold, a layer of an unfoamed or merely pre-foamed, foamable material is applied to the surface of the substrate part at a first temperature, and the foamable material is expanded at a second temperature or a succession of second temperatures which is (are) higher than the first temperature, with a chemical blowing agent or a blowing agent mixture, so that the foamable material in the expanded state fills an intermediate space between the surface of the substrate part and a molding surface of the mold and, on the one hand, bonds with the surface of the substrate part and, on the other hand, comes to bear against the molding surface.

Other features which are considered as characteristic for the invention are set forth in the appended claims.

Although the invention is illustrated and described herein as embodied in a method of fabricating a composite structure with a foamed surface, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a diagrammatic side view of a substrate structure with a foamable material layer on the substrate; and

FIG. 2 is a diagrammatic side view of the substrate, a mold, and the foamed material after it has been expanded.

### DESCRIPTION OF THE PREFERRED EMBODIMENTS

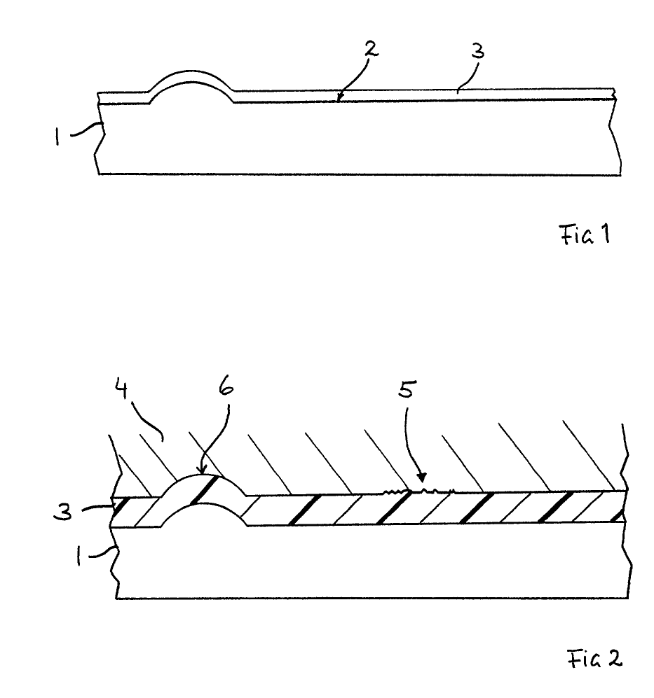

Referring now to the figures of the drawing in detail and first, particularly, to FIG. 1 thereof, there is seen a substrate 1 with a top surface 2 which is to be provided with a foamed surface. A layer 3 of unfoamed or only partly prefoamed material has been deposited on the substrate 1.

In FIG. 2, the foamable material 3 has been expanded until it touches a mold 4, having a mold shape that corresponds to the final foamed surface structure. Here, the surface is provided with grain structures 5 or the like, and a rounded, raised profile structure 6.

The substrate part 1 may be produced in the same mold 4 as the composite component, in particular by injection molding, extrusion or extrusion blow molding.

The substrate part 1 may be harder than the expanded material and, in particular, may consist of microcellular foam. Alernatively, the substrate part may consist of a softer foam material.

In a refinement of the method, it may be provided that, during or after being applied to the surface of the substrate part, the foamable material is expanded at the first temperature with a physical blowing agent and is subsequently further expanded at the second temperature(s) with a chemical blowing agent or a blowing agent mixture.

The first temperature may lie in a range from approximately 80° C. to approximately 120° C., while the second temperature may lie in a range from approximately 120° C. to approximately 250° C.

It may be provided that, instead of or in addition to the chemical blowing agent or the blowing agent mixture, microspheres are used.

A sheet-like or three-dimensionally shaped composite component may be produced, as diagrammatically indicated with the raised portion 6 and the otherwise flat layout of the composite.

The material to be foamed may be applied to the substrate part by the injection-molding, extrusion or extrusion blow-molding process.

In a refinement of the process, the above-noted grain impression may be produced on the expanded material by the appropriately shaped molding surface 5 of the mold 4.

In a further refinement of the process, it may be provided that a material for the initially unmolded substrate part is introduced into the mold, the foamable material is applied to this material and subsequently (a) the foamable material is expanded and (b) the substrate is molded, or vice versa (b, a).

An embodiment of the process is distinguished by the fact that a decorative material is applied to the still unfoamed, foamable material and, subsequently, the foamable material is expanded.

For the expanding of the foamable material 3, the cavity of the mold (the cavity defined between the surface 2 and the molding surface of the mold 4) may be increased in size.

It may be provided that the heat required for the expanding of the foamable material is introduced at least partly by the heat content of the mold.

I claim:

1. A method of producing a composite component with a foamed surface, which comprises the steps of:
placing a substrate part having a surface to be coated into a mold;
applying a layer of an unfoamed or merely pre-foamed, foamable material to the surface of the substrate part at a first temperature; and
expanding the foamable material at a second temperature higher than the first temperature, with at least one expanding aid selected from the group consisting of a chemical blowing agent, a blowing agent mixture, and microspheres, such that the
foamed material in an expanded state fills an intermediate space between the surface of the substrate part and a molding surface of the mold and, on the one hand, bonds with the surface of the substrate part and, on the other hand, comes to bear against the molding surface.

2. The method according to claim 1, wherein the expanding step comprises expanding the foamable material at a succession of different temperatures higher than the first temperature.

3. The method according to claim 1, which comprises producing the substrate part in a same mold as the composite component.

4. The method according to claim 3, which comprises producing the substrate part with a process selected from the group consisting of injection molding, extrusion, and extrusion blow molding.

5. The method according to claim 1, wherein the substrate part is harder than the expanded material.

6. The method according to claim 1, wherein the substrate part consists of a microcellular foam.

7. The method according to claim 1, wherein the substrate part consists of a foam material that is softer than the expanded material.

8. The method according to claim 1, which comprises, during or after the step of applying the foamable material to the surface of the substrate part, expanding the foamable material at the first temperature with a physical blowing agent and subsequently further expanding the foamable material at the second temperature with one of a chemical blowing agent and a blowing agent mixture.

9. The method according to claim 1, which comprises setting the first temperature in a range from approximately 80° C. to approximately 120° C.

10. The method according to claim 1, which comprises setting the second temperature in a range from approximately 120° C. to approximately 250° C.

11. The method according to claim 1, which comprises producing a sheet-like composite component.

12. The method according to claim 1, which comprises producing a three-dimensionally shaped composite component.

13. The method according to claim 1, wherein the applying step comprises applying the foamable material to the substrate part with a molding process selected from the group consisting of injection-molding, extrusion, and extrusion blow-molding.

14. The method according to claim 1, which comprises molding a grain impression on the expanded material with a suitable molding surface of the mold.

15. The method according to claim 1, which comprises introducing material for an initially unmolded substrate part into the mold, applying the foamable material to the material and subsequently expanding the foamable material and then molding the substrate.

16. The method according to claim 1, which comprises introducing material for an initially unmolded substrate part into the mold, applying the foamable material to the material and subsequently molding the substrate and then expanding the foamable material.

17. The method according to claim 1, which comprises applying a decorative material to the still unfoamed, foamable material and subsequently expanding the foamable material.

18. The method according to claim 1, which comprises increasing the cavity of the mold in size prior to the expanding step.

19. The method according to claim 1, which comprises introducing a heat quantity required for expanding the foamable material at least partly via a heat content of the mold.
